(19) United States
(12) Patent Application Publication
(10) Pub. No.: US 2019/0090468 A1
(43) Pub. Date: Mar. 28, 2019

(54) Drain Plug Screen

(71) Applicant: Paul Scott, Palm City, FL (US)

(72) Inventor: Paul Scott, Palm City, FL (US)

(21) Appl. No.: 15/871,497

(22) Filed: Jan. 15, 2018

Related U.S. Application Data
(60) Provisional application No. 62/562,498, filed on Sep. 25, 2017.

(51) Int. Cl. A01K 97/20; B01D 35/027; B01D 35/04

(52) U.S. Cl. CPC A01K 97/20; B01D 35/04; B01D 35/027

(57) ABSTRACT

A drain plug for installation into the in-floor fish-boxes on fishing boats. It is a removable and reusable filter that prevents detritus and other unwanted items from entering the fish-box drain system. The filter is a raised screen filter that allows water to drain out of the In-floor fish-box while preventing undesirable material from draining. Once the in-floor fish-box has been drained, the drain plug is removed for cleaning, and then reinstalled after cleaning.

### CROSS-REFERENCE TO RELATED APPLICATIONS

This application is related to, and claims the benefit of, the provisional patent application entitled “Drain Plug Screen”, filed Sep. 25, 2017, bearing U.S. Ser. No. 62/562,498 and naming Paul Scott, the named inventor herein, as sole inventor, the contents of which is specifically incorporated by reference herein in its entirety.

### BACKGROUND

### Technical Field

This invention relates in general to In-Floor Fish-Boxes on fishing boats. In particular, it relates to a drain plug that attaches to a fish-box drain tube, macerator pump or diaphragm pump. The drain plug screen prevents fish scales, fish parts, pieces of bait hooks, fishing line, sinkers or other objects from entering the fish-box drain tube and macerator pump.

### Background of the Invention

There is typically an in-floor fish-box in many sports and recreational boats. In addition to the many commercial fishing boats also use in-floor fish-boxes. The purpose of these in-floor fish-boxes is to keep both fish and bait cold until the boat returns to shore. Once the fishing trip is complete the in-floor fish-box is emptied and cleaned. Part of the cleaning process usually entails draining the residue from the in-floor fish-box through the macerator pump, or diaphragm pump and out of the boat.

A problem associated with the cleaning process is that there is often a variety of undesirable material that is inadvertently moved through the macerator or diaphragm pump. For example, broken hooks pieces of fishing line, etc. In addition, portions of the fish catch may also wind up being flushed through the macerator or diaphragm pump. Often, some of the residue becomes trapped inside macerator or diaphragm pump or other parts of the fish-box pump out system. When this happens, there is a possibility of a rapid buildup of bacteria as well as a foul odor. Since boats are usually designed to maximize usable space, getting to the components of fish-box pump out system that need to be cleaned may involve considerable work. It would be desirable to allow water to free flow to Fish-box drain tube, macerator pump or diaphragm pump while preventing undesired items from entering the fish-box pump out system when the in-floor fish-box is being cleaned.

In addition to problems related to odor and bacteria, metal parts, such as fish hooks, may damage components as they are moved through the system. It would be desirable to retain any unwanted materials that are inadvertently deposited in the in-floor fish-box such that those unwanted materials are prevented from entering and potentially damaging other components of the fish-box pump out system.

Since In-floor fish-boxes typically have a substantial amount of ice to keep the catch cold, there often problems caused by large pieces of ice clogging the in-floor fish-box drain. While the ice will melt, it will also delay the process of cleaning the in-floor fish-box and other components of the boat. It would therefore be desirable to prevent the drain from being clogged by large pieces of ice.

If the boater cleans the fish before returning to shore, there may be a substantial amount of undesirable fish parts such as fish scales or pieces of bait. These may also clog the fish-box drain, the macerator pump, or the diaphragm pump. Of course, this will result in the same bacteria and odor problems discussed above. It would be desirable to retain those fish parts in the in-floor fish-box so that they can be more easily removed.

While the prior art has provided a variety of drain plugs, it has failed to provide a drain plug that allows water to be drained from an in-floor fish-box while filtering detritus and other unwanted items from entering the fish-box pump out system.

### SUMMARY OF THE INVENTION

This invention provides a drain plug that is installed in the in-floor fish-boxes of fishing boats. It is a removable and reusable filter that prevents detritus and other unwanted items from entering the fish-box pump out system. The filter is a raised screen filter that allows water to drain out of the in-floor fish-box while preventing undesirable material from entering the fish-box pump out system. Once the in-floor fish-box has been drained, the drain plug screen is removed for cleaning, along with the detritus and other unwanted items. After cleaning, the drain plug is then reinstalled.

### BRIEF DESCRIPTION OF THE DRAWINGS

FIG. 1 illustrates a top view of a preferred embodiment of the drain plug.

FIG. 2 illustrates a side view of a preferred embodiment of the drain plug.

### DETAILED DESCRIPTION OF THE PREFERRED EMBODIMENT

Prior to a discussion of the figures, a general overview of the invention will be presented.

The drain plug provided by this invention is an elevated screen that plugs into the drain of an in-floor fish-box. It provides a barrier that prevents detritus, unwanted items, fish scales, pieces of bait, fish parts, fish hooks, fishing line, sinkers or other objects from entering the drain while allowing water to freely flow to the fish-box drain tube, macerator pump or diaphragm pump. In addition, it also keeps ice from reducing water flow by clogging the fish-box drain. In addition, it significantly reduces the potential for bacteria growth as well as the offensive smell of fish scales, bait and fish parts that may become lodged in the fish-box drain tube and bilge system.

In the preferred embodiment, the drain plug uses a mesh filter suitable for allowing fluids to pass through while preventing solid items from entering the drain. For ease of illustration, the mesh filter illustrated in the figures shows an open weave. However, in the preferred environment, the mesh filter used by the invention would typically have a very small mesh weave such that fluids can pass through and solid particles could not pass through and enter the drain.

The mesh filter is fabricated from any material that is suitable for use in a hostile marine environment. The materials used should be selected based on their durability, reusability, and ability to be easily cleaned. While stainless steel can be used, other metals, such as bronze, can also be used. Further, any other metal suitable for use in a hostile marine environment can be used to fabricate the mesh filter.

In addition to metal, the mesh filter may also be fabricated from any other material that is suitable for use in a hostile marine environment. For example, synthetic materials. Virgin nylon, PVC, polyethylene or plastic are examples of suitable synthetic materials. As noted above, the materials used should be selected based on their durability, reusability, ability to be easily cleaned, and suitable for use in a hostile marine environment.

While the preferred embodiment envisions a reusable drain plug, it is also possible to fabricate the drain plug such that it is disposable.

Having discussed an overview of the invention, we turn now to a discussion of the figures.

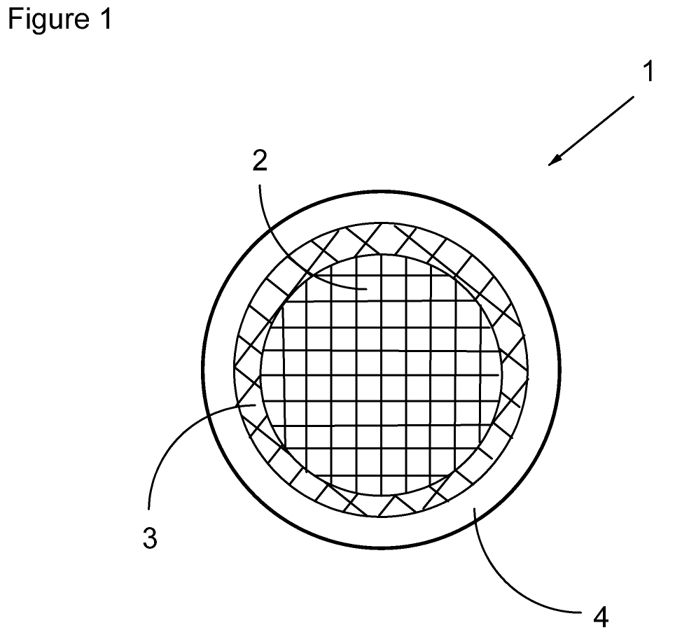

FIG. 1 illustrates a top view of a preferred embodiment of the drain plug 1. The drain plug 1 has a top surface 2 fabricated from a wire mesh material. The top surface 2 curves at outer edge 3 and descends down to the base plate 4.

The wire mesh material is shown as having substantial openings for ease of illustration. However, in practice, the wire mesh will have opening sized to allow fluids to pass through, but substantially block all solid material, such as debris and solids, held in the in-floor fish-box from entering the fish-box purge system. As noted elsewhere, the mesh can be fabricated from any suitable material, so long as it has both suitable mechanical strength to perform its function, and also is fabricated from material that is usable in a harsh marine environment. The materials can be metals, such as stainless steel, bronze, etc., on non-metals, such as virgin nylon, polyethylene, PVC, plastic, etc.

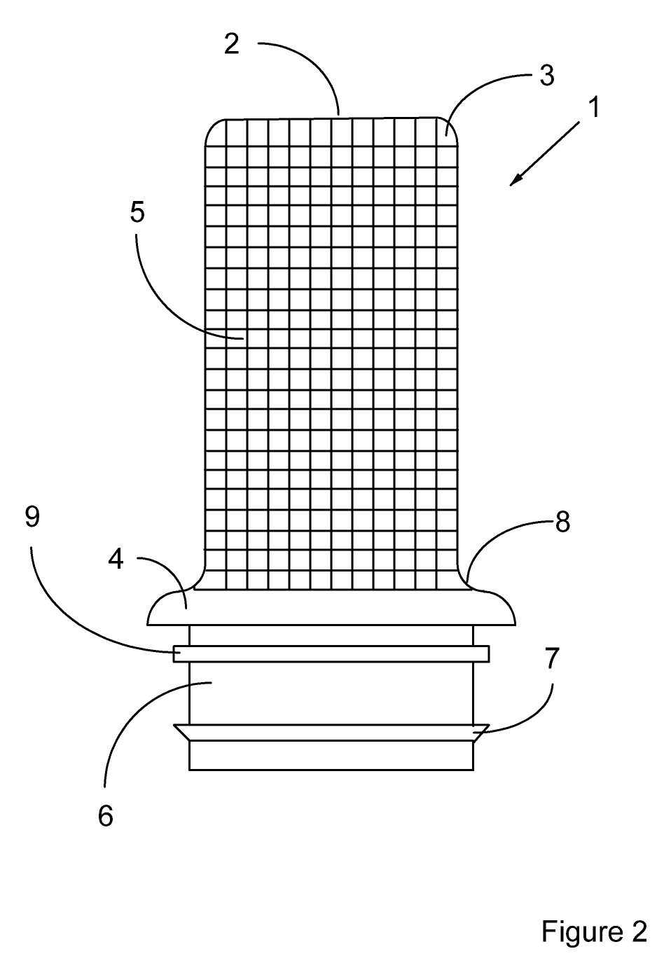

FIG. 2 illustrates a side view of a preferred embodiment of the drain plug 1. The top surface 2 curves downward at side edge 3. The side surface 5 extends downward and joins the base plate 4 at point 8. Illustrated below the base plate 4 is the plug 6 that is inserted into the drain opening (not shown). Gasket 7 extends from the side of the plug 6 to make a watertight fit between the drain plug 1 and the drain opening of the in-floor fish-box such that nothing enters the drain opening unless it first passes through the wire mesh 2, 3, 5.

Also shown in FIG. 2 is optional ridge 9 that helps stabilize the drain plug 1 when is inserted into the drain opening of the in-floor fish-box.

In the preferred embodiment, the drain plug 1 uses a simple pressure fit, being held in place by gasket 7. This allows a simplicity of design, and further allows easy installation and removal of the drain plug 1. However, those skilled in the art will realize that alternative installation methods are possible, such as a threaded base that screws into the in-floor fish-box.

An important feature of the invention is the raised structure of the mesh material used by drain plug 1. While a simple flat screen would initially work, it could easily be clogged by detritus during use. By shaping the wire mesh into a raised structure, as shown in FIG. 2, the possibility of clogging the wire mesh is greatly reduced. Of course, the shape of the wire mesh can be varied to suit different design goals.

The base 4, plug 6, and ridge 9.

When the in-floor fish-box is cleaned, the drain plug 1 is removed and cleaned outside of the in-floor fish-box, and then reinstalled.

As can be seen, the invention provides an effective method of preventing undesired material from draining out of the in-floor fish-box. It is inexpensive, easy to install and remove, and prevents a number on desirable items from entering the bilge system.

While specific embodiments have been discussed to illustrate the invention, it will be understood by those skilled in the art that variations in the embodiments can be made without departing from the spirit of the invention. The types of materials used can vary, the method of attachment can vary, etc. Therefore, the invention shall be limited solely to the scope of the claims.

I claim:

1. A raised drain plug for an in-floor fish-box attached to a drain tube of a boat, comprising:
an in-floor fish-box with a drain opening providing access to a drain tube on a boat;
a removable drain plug, the drain plug draining through the drain opening and into the drain tube of a boat;
the drain plug further comprising a base plate connected to a mesh filter;
the mesh filter further extending upward from the base plate such that liquids in the in-floor fish-box pass through sides of the mesh filter and detritus and debris from fish or other seafood are prevented from passing through the mesh filter;
the mesh filter further extending from the base plate such that substantially all liquid in the in-floor fish-box flows from the in-floor fish-box into the drain tube; and
the drain plug further extending downward from the base plate, the portion of the drain plug that extends downward is sized to snugly fit in the drain opening of the in-floor fish-box and the drain tube;
whereby detritus and/or debris is prevented from entering the boat's drain tube.

2. A raised drain plug screen, as in claim 1, further comprising:
a gasket extending from the periphery of the drain plug, such that the drain plug is snugly secured to the inside of the drain tube by the gasket with a watertight fit.

3. A raised drain plug screen, as in claim 2, further comprising:
a ridge extending from the periphery of the drain plug, the ridge and the gasket working in conjunction to stabilize the drain plug when it is secured inside of the drain.

4. A raised drain plug screen, as in claim 1, wherein:
the mesh filter is fabricated from synthetic material.

5. A raised drain plug screen, as in claim 4, wherein:
the synthetic material is virgin nylon, polyethylene, PVC, or plastic.

6. A raised drain plug screen, as in claim 1, wherein:
the mesh filter is fabricated from metal.

7. A raised drain plug screen, as in claim 6, wherein:
the metal is stainless steel, or bronze.

8. A raised drain plug screen, as in claim 1, wherein:
the base plate is fabricated from non-corrosive material.

9. A raised drain plug screen, as in claim 8, wherein:
the base plate is fabricated from stainless steel, bronze, virgin nylon, polyethylene, PVC, or plastic.

10. A raised drain plug screen, as in claim 1, wherein:
the raised drain plug is disposable.

11. A raised drain plug screen, as in claim 1, wherein:
the raised drain plug is reusable.
